(19) United States
(12) Patent Application Publication
(10) Pub. No.: US 2009/0267866 A1
(43) Pub. Date: Oct. 29, 2009

(54) LAPTOP COMPUTER WITH A BACK TO BACK DISPLAY

(76) Inventors: Degapudi Janardhana Reddy, Chennai (IN); Lakshmanan Narayanan, Chennai (IN)

Correspondence Address: ABELMAN, FRAYNE & SCHWAB, 666 THIRD AVENUE, 10TH FLOOR, NEW YORK, NY, 10017, US

(21) Appl. No.: 11/913,631

(22) PCT Filed: May 24, 2005
(86) PCT No.: PCT/IN05/00162

§ 371 Date: Nov. 5, 2007

(30) Foreign Application Priority Data
May 5, 2005 (IN) IN532/CHE/2005

(51) Int. Cl. G09G 5/12

(52) U.S. Cl. 345/1.1

(57) ABSTRACT

A back-to-back dual display laptop notebook computer enables a presenter and recipient passive viewers sitting opposite to each other to simultaneously view the back-to-back display through a master display and a slave display, respectively, with master and slave display units selectively switched off for use as a normal laptop computer, or for use of the slave display independently by switching the slave display to be upside down.

### CROSS-REFERENCE TO RELATED APPLICATIONS

This application is a 371 of international application number PCT/IN2005/000162, filed on May 24, 2005.

### BACKGROUND OF THE INVENTION

1. Field of the Invention

This invention relates to the computers and in particular to laptop and notebook computers. More specifically, the invention relates to a display monitor which is an output device and the invention helps in the presentation of documents and materials with ease, convenience and comfort.

2. Description of the Related Art

In the prior art, notebook computers are used in particular by doctors, sales and marketing professionals and others to present pictorial clinical conditions or data either to a patient or to customers and prospective clients respectively in a one-to-one or one-to-many-person situations. The patients, clients or customers are in one or more small groups of people in an office setting sitting opposite to the presenter across the table.

It is customary for laptop notebook computers to have a single display of thin-film transistors (TFTs) of different sizes in a flipbook type configuration. To view the display, the flipbook needs to be opened and once opened the display angle is adjusted by moving or tilting the flipbook for better view ability. Generally these laptop computers are meant for self/personal use and are single user mobile computers units for their individual purposes and are not meant for presentations. When laptop notebook computers are used by more than one person either to present data or visuals/presentations then all are forced to sit in the same line-of-sight opposite to the laptop computer as shown in FIG. 1 which is very difficult and uncomfortable in any sales/client settings.

Typically the presenter tries to put on the presentation, and for that type of use, he has to properly position the computer maybe at a 45 degree angle to both to the customer and to himself so that both can view of the screen. The display types of laptop notebook computers in the prior art are prone to viewing angle problems due to the use of TFT displays and/or other liquid crystal displays (LCDs), and such viewing angle problems put pressure and strain on the presenter as well as the viewer. Many times the presenter and the view have to adjust their seating posture by leaning over the table upon which the computer is placed to get a glimpse of what is being presented on the screen, or sometimes the presenter finds it more difficult to view as well as to present the data or he has to memorize the whole screen and commonly he loses concentration especially when interrupted. Many sales presentation at customer premises do not impress the customer due to the viewing angle problems and so the presentation is a failure.

In a typical case involving a cardio thoracic surgeon explaining the cardiac block using a filmed angiography recording to his patient sitting opposite to him across a table using his laptop computer, the patient will find it difficult to see the notebook computer LCD properly as explained by the surgeon.

There have been some attempts to overcome these presentation and viewing problems by introducing a model in which the LCD display can be tilted and rotated from bottom to top. However, such attempts still have the limitation that either only the presenter or only the client can view the display at any time with ease.

### BRIEF SUMMARY OF THE INVENTION

The technique of using a back-to-back replicated display facility for laptop notebook computers of the present invention presents an unique approach to revolutionize the concept of usage of laptop notebook computers. This will popularize the use of laptop notebook computers in better ways and to understand and exchange ideas at ease. Also this invention opens up unlimited possibilities of usage with proper software written to utilize this feature in areas such as teaching, clinical meetings, and sales presentations to name a few.

The heart of the invention is a pair of display parts to replicate the contents displayed by one display part in another display part. The present invention is directed to providing an apparatus that overcomes the foregoing and other disadvantages of the prior art. More specifically, the present invention is directed to providing a method for the simultaneous viewing of a screen by the presenter 7 as well as by a client 8 sitting quite opposite to each other as illustrated in FIGS. 2A-2B.

A back-to-back dual facility in a laptop notebook computer having two back-to-back TFT LCD displays is disclosed. A plurality of display devices 2 is added back-to-back so that a second slave display 2 will face the client 8 sitting opposite the presenter.

In accordance with one aspect of invention, as both the displays are of same type and same size, and also from same manufacturer, the drive signals are similar in nature and generally the signals are as listed in FIG. 7. These signals are to be buffered by a set of high speed buffers as shown in FIG. 6 and wired to the second slave device 2.

In accordance with still another aspect of invention, in FIG. 6, by switching off the power signals from a 3.3V supply to the TFT LCD display part along with a backlight source input supply 15, the second slave display 2 is switched off. Now the laptop computer can be used as a normal one by an single user. For this mode of use, a key 12 is provided in the laptop computer so that user can selectively switch off the second slave display 2.

In accordance with still another aspect of invention, a signal generally available in LCDs, namely R/L and V/D, can be utilized to switch the whole display upside down by using a key 13 by controlling the signal 16. It is a very useful in using the slave display 2 when the flipbook laptop notebook computer is fully or partly closed, and still allowing the user to view the screen by using this key 13 and also to use the computer as a notebook computer with an external keyboard and mouse connected.

In accordance with yet another aspect of invention, one of the displays can be switched off while not in use or when not required either by software or by hardware.

In accordance with another aspect of invention, the dual display is a replica of the display parts in which the TFT LCD screen is fixed back-to-back as shown in either of FIGS. 2A and 2B, along with the suitable signal drive mechanism. The second slave display 2 is protected by a protective shield with clear transparent sheet fixed over the display part 2 which has the strength to withstand any hard hitting of the display area.

Also many protective mechanisms can be provided to shield the exposed second slave display 2 apart from any physical damage while not in use, while in transport etc. Some of these protective mechanisms may include a permanent transparent plastic sheet attached to pluggable or slidable door-like shutters to give mechanical protection against the outside environment. It would be appreciated that various changes can be made therein without departing from the scope and spirit of this invention.

It will be appreciated that the disclosed method and circuit is advantageous in that it allows another passive viewer 8 to have a replicated view of the presenter screen 1. To assist with understanding the invention, reference will be made to the accompanying drawings, which show one example of invention.

The present invention includes a back-to-back replicated display in a notebook computer having a basic master display in the upper side of the flipbook notebook computer facing the presenter/operator, and a slave display exactly fitting the back of the master display in the upper side of the flipbook notebook computer facing the viewer or persons sitting opposite to the owner/operator in which the master and slave display units can be controlled independently to adjust or modify the display of different features such as upside-down, tilt, and power off.

### BRIEF DESCRIPTION OF THE SEVERAL VIEWS OF THE DRAWINGS

The foregoing aspects and many of the attendant advantages of this invention will become more readily appreciated as the same becomes better understood by reference to the detailed description, when taken in conjunction with the accompanying drawings.

FIG. 1 illustrates a laptop computer showing the presenter 5 and the passive viewers 4 and 6 in a user-client setting in a discussion normally in a prior art.

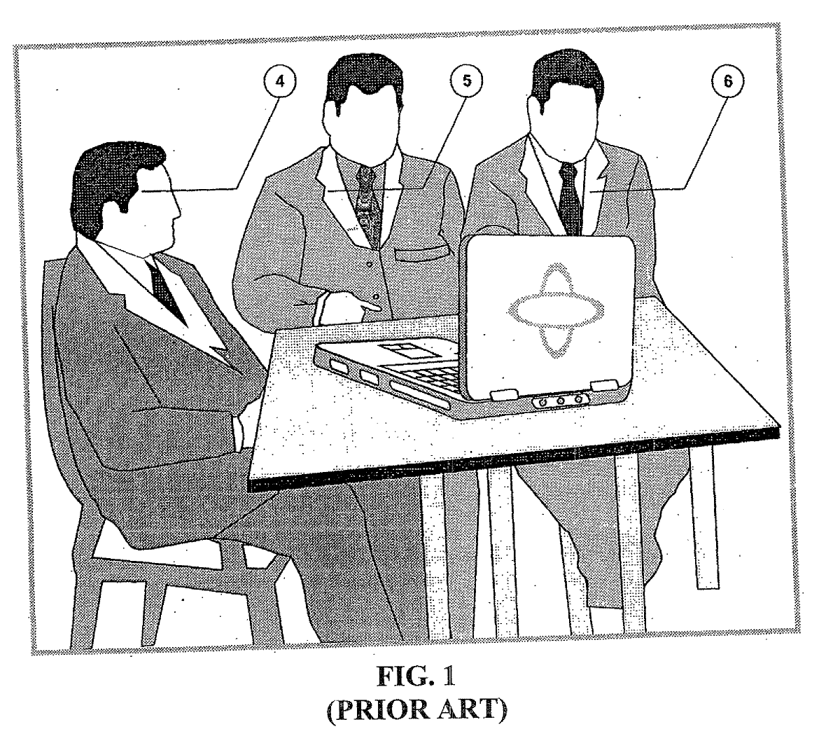

FIGS. 2A and 2B illustrate a laptop computer exposing the second slave display which shows the present invention, in which the slave display can also be made to open as a flipbook independently as in FIG. 2B for better viewing comfort of the viewer. Here both the presenter 7 and the viewer 8 can see the presentation with ease.

FIG. 3 illustrates a notebook computer 3 exposing the inner display called the master display 1.

FIG. 4 illustrates different views of the present invention for simultaneous viewing ability.

FIG. 5 illustrates the second slave display.

FIG. 6 shows how both LCDs are interconnected to have a dual replica of images.

FIG. 7 shows all generic TFT LCD input interface signals.

### DETAILED DESCRIPTION OF THE PREFERRED EMBODIMENTS

The present invention is related to international application number PCT/IN2005/000162, filed on May 24, 2005, which is incorporated herein by reference in its entirety.

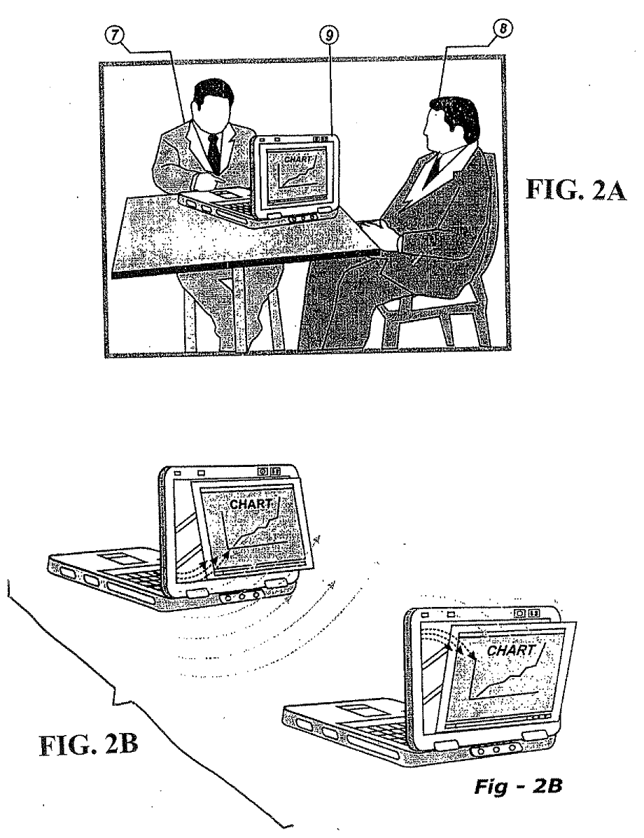

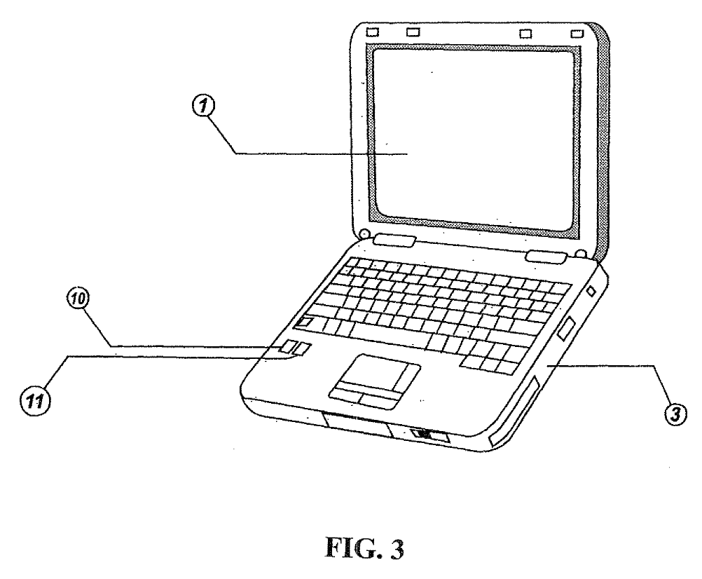

The general operation of the preferred embodiment of the present invention is illustrated in FIGS. 2A and 2B in conjunction with FIGS. 3-7. Both the LCD displays are packed back-to-back either as in FIG. 2A or 2B with an electrical non-conductor and a shock absorbent, and housed in the top portion of the laptop with hinges. The mechanical housing is made such that it protects both of the LCDs and is also sleek as far as possible.

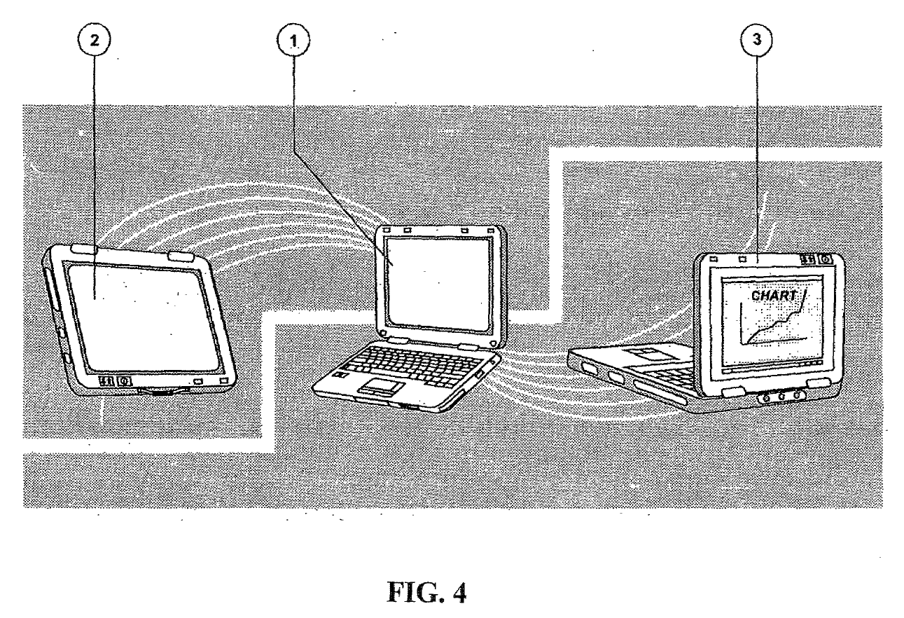

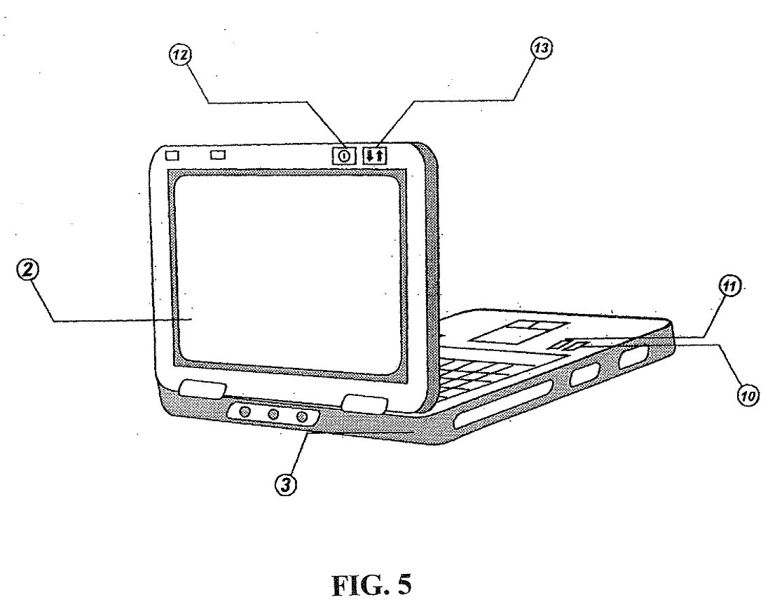

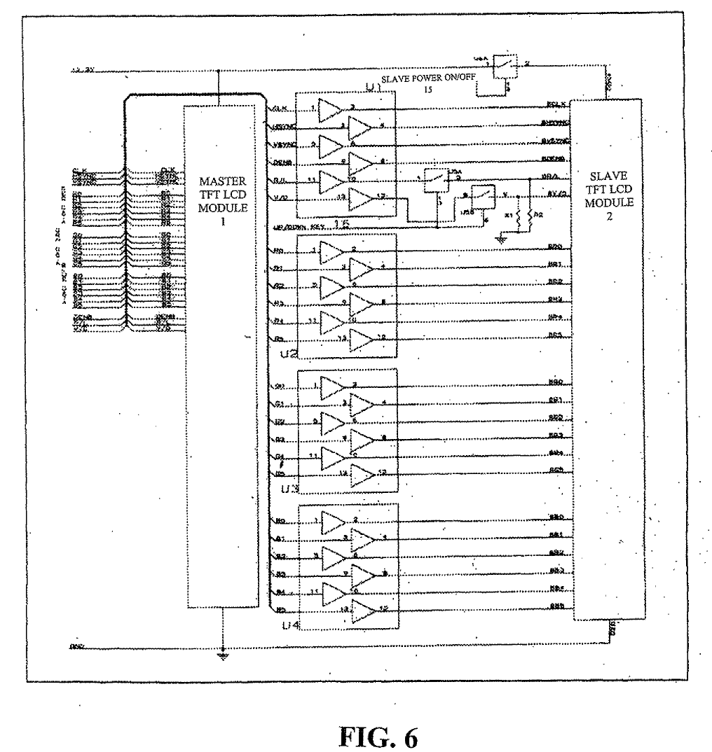

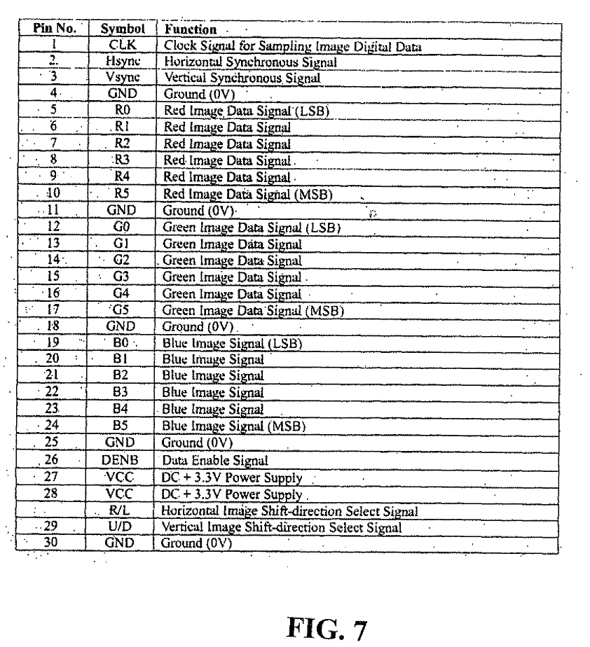

FIG. 3 illustrates a notebook computer 3 including a processor and memory, with the notebook computer 3 flipped open for exposing the inner display called the master display 1 with control switches 10, 11. FIG. 4 illustrates different views of the present invention for simultaneous viewing ability from different angular directions, such as over 90°, and substantially or identically equal to 180°. FIG. 5 illustrates the second slave display 2 with ON/OFF switch 12 for turning off only the second slave display 2. The second slave display 2 also includes an image inverting switch 13 for flipping the image on the second slave display 2 to be upside down relative to the image on the master display 1, but when viewed by an outside viewer the upside down image appears right side up. FIG. 6 shows how both LCDs of the display units 1, 3 are interconnected to have a dual replica of images. FIG. 7 shows all generic TFT LCD input interface signals.

FIG. 6 illustrates how the two TFT LCDs are wired together to get a replica image on the screen. The LCD1 is the master LCD 1 which is located inside the computer as shown in FIG. 2A. The LCD2 is the slave LCD (2) which is located outside of the computer as shown in FIGS. 2A. The color signals RGB of each 6 bits which are outputted by the VGA Card from the display driver sub systems of the computer are buffered by three corresponding high speed buffers U2 to U4 and connected to the LCD2. Similarly for the CLK, HSYNC, and VSYNC signals, these three vital signals are again buffered by high speed buffers U1 and connected to LCD2. The other signals of the LCD1: the Data Enable (DENB) signal, the Horizontal Image Shift Direction Select (R/L) signal, and the Vertical Image Shift Direction Select (U/D) signal are again buffered and connected to LCD2 via an analog switch 13. This analog switch facilitates the directional change of image in LCD from right to left and normal vertical orientation to upside-down orientation by grounding the lines of LCD2.

It will be appreciated that the high speed buffers U1 to U4 allow another LCD to be wired with the same identical similar LCD to have a replica image on the screen. The slave display unit is connected to the master display unit and computer as in FIG. 6 with the signals as in FIG. 7.

Also it will be appreciated that using a semiconductor power switch 12 such as a MOSFET power switch to the slave LCD display can be switched ON and OFF as desired by the user. Also, by using a high speed analog switch 13 across the lines of R/L and V/D, the user can switch the whole picture displayed on display unit 2 upside down.

The technique of using a back-to-back replicated display facility for laptop notebook computers of the present invention presents an unique approach to revolutionize the concept of usage of laptop notebook computers. This will popularize the use of laptop notebook computers in better ways and to understand and exchange ideas at ease. Also this invention opens up unlimited possibilities of usage with proper software written to utilize this feature in areas such as teaching, clinical meetings, and sales presentations to name a few.

The heart of the invention is a pair of display parts to replicate the contents displayed by one display part in another display part. The present invention is directed to providing an apparatus that overcomes the foregoing and other disadvantages of the prior art. More specifically, the present invention is directed to providing a method for the simultaneous viewing of a screen by the presenter 7 as well as by a client 8 sitting quite opposite to each other as illustrated in FIGS. 2A-2B.

A back-to-back dual facility in a laptop notebook computer having two back-to-back TFT LCD displays is disclosed. A plurality of display devices 2 is added back-to-back so that a second slave display 2 will face the client 8 sitting opposite the presenter.

In accordance with one aspect of invention, as both the displays are of same type and same size, and also from same manufacturer, the drive signals are similar in nature and generally the signals are as listed in FIG. 7. These signals are to be buffered by a set of high speed buffers as shown in FIG. 6 and wired to the second slave device 2.

In accordance with still another aspect of invention, in FIG. 6, by switching off the power signals from a 3.3V supply to the TFT LCD display part along with a backlight source input supply 15, the second slave display 2 is switched off. Now the laptop computer can be used as a normal one by an single user. For this mode of use, a key 12 is provided in the laptop computer so that user can selectively switch off the second slave display 2.

In accordance with still another aspect of invention, a signal generally available in LCDs, namely R/L and V/D, can be utilized to switch the whole display upside down by using a key 13 by controlling the signal 16. It is a very useful in using the slave display 2 when the flipbook laptop notebook computer is fully or partly closed, and still allowing the user to view the screen by using this key 13 and also to use the computer as a notebook computer with an external keyboard and mouse connected.

In accordance with yet another aspect of invention, one of the displays can be switched off while not in use or when not required either by software or by hardware.

In accordance with another aspect of invention, the dual display is a replica of the display parts in which the TFT LCD screen is fixed back-to-back as shown in either of FIGS. 2A and 2B, along with the suitable signal drive mechanism. The second slave display 2 is protected by a protective shield with clear transparent sheet fixed over the display part 2 which has the strength to withstand any hard hitting of the display area.

Also many protective mechanisms can be provided to shield the exposed second slave display 2 apart from any physical damage while not in use, while in transport etc. Some of these protective mechanisms may include a permanent transparent plastic sheet attached to pluggable or slidable door-like shutters to give mechanical protection against the outside environment. It would be appreciated that various changes can be made therein without departing from the scope and spirit of this invention.

It will be appreciated that the disclosed method and circuit is advantageous in that it allows another passive viewer 8 to have a replicated view of the presenter screen 1.

As generally described herein with reference to FIGS. 2A-7, the integrated display screen laptop computer of the present invention includes a processor for generating display signals; and first and second display units connected to the processor, with the first and second display units oriented at an angle for displaying identical images generated from the display signals, wherein the identical images are viewable at different orientations. The angle may be exactly 180°, whereby the first and second display units form a back-to-back display configuration. Alternatively, may be greater than 90°, include about 180°.

The processor may include a control switch for controlling the first and second display units. The control switch may include an OFF switch for switching off a selected one of the first and second display units. A first display unit may operate as a master display unit presenting a first image, with the second display unit operating as a slave display unit presenting the first image, and the OFF switch switches off only the second display unit. Alternatively, the first display unit operates as a master display unit presenting a first image in a first orientation, and the second display unit operates as a slave display unit presenting a second image identical to the first image in the first orientation, with the control switch includes an image inverting switch for inverting the second image presented on the slave display unit to be in a second orientation upside down relative to the first orientation.

In alternative embodiments, the present invention provides an apparatus for constructing an integrated back-to-back display screen laptop computer, including first and second thin-film transistor liquid crystal display (TFT LCD) units fixed back-to-back to form a single flipbook configuration of the laptop computer, with each TFT LCD unit including a display graphic processor originating transmission minimized differential signaling (TMDS) signals for generating a displayed respective image, a low voltage differential signaling (LVDS) drive buffer circuitry for buffering the TMDS signals and for driving the TFT LCD to display the respective image, a TFT LCD signal interface connector end for communicating TMDS signals between the first and second TFT LCD units, and a impedance matching terminator provided at each of the TFT LCD signal interface connector end, with an electromagnetic interference (EMI) shield positioned in between the display TFT LCD units, such that the communicating of TMDS signals between the first and second TFT LCD units causes each displayed image on the first and second TFT LCD to be a common image.

The apparatus may also include a Random Access Memory Digital-to-Analog Converter (RAMDAC) included in at least one of the first and second TFT LCDs, with the first TFT LCD unit being driven by LVDS signals from its respective display graphic processor to display a first image, and the second TFT LCD unit being driven from the output of a RAMDAC to display to display a second image different from the first image.

An independent cold cathode fluorescent lamp (CCFL) inverter switch may be provided for each TFT LCD unit to control the respective TFT LCD unit to be used as one of a single screen, a dual screen, or a tablet computer. A non-obstructive transparent protective cover may be affixed permanently at least one of the first and second TFT LCD display units.

The first TFT LCD display unit operates as a master display unit presenting a first image, and the second TFT LCD display unit operates as a slave display unit presenting a second image identical to the first image.

The present invention also includes a method for displaying images at different viewable orientations using a laptop computer, with the method including the steps of: providing the laptop computer with a processor and first and second display units connected to the processor, generating display signals from the processor, displaying identical images generated from the display signals on the first and second display units, and orientating the first and display units at an angle, thereby presenting the identical images at different viewable orientations.

The angle may be exactly or about 180°, such that the first and second display units form a back-to-back display configuration. Alternatively, the angle is greater than 90°. The method may also include includes providing a control switch on the processor for controlling the first and second display units. The control switch includes an OFF switch for switching off a selected one of the first and second display units.

The method includes having the first display unit operate as a master display unit presenting a first image, and the second display unit operate as a slave display unit presenting the first image, with the OFF switch switching off only the second display unit.

In an alterative embodiment, the method includes having first display unit operate as a master display unit presenting a first image in a first orientation, the second display unit operates as a slave display unit presenting a second image identical to the first image in the first orientation, with the control switch includes an image inverting switch for inverting the second image presented on the slave display unit to be in a second orientation upside down relative to the first orientation.

While the preferred embodiments of the invention has been illustrated and described, it will be apparent that various changes can be made therein without departing from the spirit and scope of the invention. For example, dissimilar display devices can be wired as long as the signal conversion or modification is done to suit the requirements of the LCDs. Consequently, within the scope of the appended claims, it will be appreciated that the invention can be practiced otherwise than as specifically described herein.

What is claimed is:

1-5. (canceled)

6. An apparatus for constructing an integrated back-to-back display screen laptop computer, the apparatus comprising:
first and second thin-film transistor liquid crystal display (TFT LCD) units fixed back-to-back to form a single flipbook configuration of the laptop computer, wherein each TFT LCD unit includes:
a display graphic processor originating transmission minimized differential signaling (TMDS) signals for generating a displayed respective image;
a low voltage differential signaling (LVDS) drive buffer circuitry for buffering the TMDS signals and for driving the TFT LCD to display the respective image;
a TFT LCD signal interface connector end for communicating TMDS signals between the first and second TFT LCD units; and
a impedance matching terminator provided at each of the TFT LCD signal interface connector end; and
an electromagnetic interference (EMI) shield positioned in between the display TFT LCD units;
wherein the communicating of TMDS signals between the first and second TFT LCD units causes each displayed image on the first and second TFT LCD to be a common image.

7. The apparatus of claim 6, further comprising:
a Random Access Memory Digital-to-Analog Converter (RAMDAC) included in at least one of the first and second TFT LCDs;
wherein the first TFT LCD unit is driven by LVDS signals from its respective display graphic processor to display a first image; and
wherein the second TFT LCD unit is driven from the output of a RAMDAC to display to display a second image different from the first image.

8. The apparatus of claim 6, further comprising:
an independent cold cathode fluorescent lamp (CCFL) inverter switch provided for each TFT LCD unit to control the respective TFT LCD unit to be used as one of a single screen, a dual screen, or a tablet computer.

9. The apparatus of claim 6, further comprising:
a non-obstructive transparent protective cover affixed permanently at least one of the first and second TFT LCD display units.

10. The apparatus of claim 6, wherein the first TFT LCD display unit operates as a master display unit presenting a first image; and
wherein the second TFT LCD display unit operates as a slave display unit presenting a second image identical to the first image.

11. An integrated display screen laptop computer comprising:
a processor for generating display signals; and
first and second display units connected to the processor, with the first and second display units oriented at an angle for displaying identical images generated from the display signals, wherein the identical images are viewable at different orientations.

12. The integrated display screen laptop computer of claim 11, wherein the angle is 180°, whereby the first and second display units form a back-to-back display configuration.

13. The integrated display screen laptop computer of claim 11, wherein the angle is about 180°.

14. The integrated display screen laptop computer of claim 11, wherein the angle is greater than 90°.

15. The integrated display screen laptop computer of claim 11, wherein the processor includes a control switch for controlling the first and second display units.

16. The integrated display screen laptop computer of claim 15, wherein the control switch includes an OFF switch for switching off a selected one of the first and second display units.

17. The integrated display screen laptop computer of claim 16, wherein a first display unit operates as a master display unit presenting a first image; and
wherein the second display unit operates as a slave display unit presenting the first image; and
wherein the OFF switch switches off only the second display unit.

18. The integrated display screen laptop computer of claim 15, wherein a first display unit operates as a master display unit presenting a first image in a first orientation; and
wherein the second display unit operates as a slave display unit presenting a second image identical to the first image in the first orientation; and
wherein the control switch includes an image inverting switch for inverting the second image presented on the slave display unit to be in a second orientation upside down relative to the first orientation.

19. A method for displaying images at different viewable orientations using a laptop computer, the method comprising the steps of:
providing the laptop computer with a processor and first and second display units connected to the processor;
generating display signals from the processor; and
displaying identical images generated from the display signals on the first and second display units; and
orientating the first and display units at an angle, thereby presenting the identical images at different viewable orientations.

20. The method of claim 19, wherein the angle is 180°, whereby the first and second display units form a back-to-back display configuration.

21. The method of claim 19, wherein the angle is greater than 90°.

22. The method of claim 19, further comprising the step of:
providing a control switch on the processor for controlling the first and second display units.

23. The method of claim 22, wherein the control switch includes an OFF switch for switching off a selected one of the first and second display units.

24. The method of claim 23, wherein a first display unit operates as a master display unit presenting a first image; and
wherein the second display unit operates as a slave display unit presenting the first image; and
wherein the OFF switch switches off only the second display unit.

25. The method of claim 23, wherein a first display unit operates as a master display unit presenting a first image in a first orientation; and
wherein the second display unit operates as a slave display unit presenting a second image identical to the first image in the first orientation; and
wherein the control switch includes an image inverting switch for inverting the second image presented on the slave display unit to be in a second orientation upside down relative to the first orientation.
